(19) United States
(12) Patent Application Publication
(10) Pub. No.: US 2006/0146062 A1
(43) Pub. Date: Jul. 6, 2006

(54) Method and apparatus for constructing classifiers based on face texture information and method and apparatus for recognizing face using statistical features of face texture information

(75) Inventors: Seokcheol Kee, Seoul (KR); Bin Xu, Beijing (CN); Yangsheng Wang, Beijing (CN); Ziqing Li, Beijing (CN); Xiangsheng Huang, Beijing (CN); Xiaouxu Zhou, Beijing (CN)

Correspondence Address: STAAS & HALSEY LLP, SUITE 700, 1201 NEW YORK AVENUE, N.W., WASHINGTON, DC, 20005, US

(73) Assignees: Samsung Electronics Co., Ltd., Suwon-si (KR); Institute of Automation Chinese Academy of Sciences, Beijing (CN)

(21) Appl. No.: 11/320,672

(22) Filed: Dec. 30, 2005

(30) Foreign Application Priority Data
Dec. 30, 2004 (CN) 200410101879.5
Jun. 1, 2005 (KR) 10-2005-0046683

(51) Int. Cl. G09G 5/00

(52) U.S. Cl. 345/582

(57) ABSTRACT

A method and an apparatus for constructing classifiers based on face texture information and a method and an apparatus for recognizing a face using statistical features of texture information. The method of constructing classifiers based on face texture information includes: cropping a first face image and a second face image from two different images; dividing the first face image and the second face image into partial images of predetermined sizes and cropping first partial images corresponding to the first image and second partial images corresponding to the second image; extracting first texture information corresponding to texture information of each of the first partial images and second texture information corresponding to texture information of each of the second partial images; checking similarities between the texture information of partial images of the first face image and that of the corresponding partial images of the second face image; and constructing weak classifiers for recognizing an identity of the face based on partial images according to the checked similarities.

### CROSS-REFERENCE TO RELATED APPLICATIONS

This application claims the benefit of Korean Patent Application No. 10-2005-0046683, filed on Jun. 1, 2005, in the Korean Intellectual Property Office, and the benefit of Chinese Patent Application No. 200410101879.5, filed on Dec. 30, 2004, in the Chinese Patent Office, the disclosures of which are incorporated herein in its entirety by reference.

### BACKGROUND OF THE INVENTION

1. Field of the Invention

The present invention relates to biometric technologies such as face recognition technology, and more particularly, to a method and an apparatus for constructing classifiers for face recognition using statistical features of face texture information, and a method and an apparatus for recognizing a face using the constructed classifiers

2. Description of Related Art

Nowadays, many agencies, companies, or other types of organizations require their employees or visitors to use an admission card for identification purposes. Thus, each person receives a key card or a keypad that is used in a card reader and must be carried all the time when the person is within designated premises. In this case, however, when a person loses the key card or keypad or has it stolen, an unauthorized person may access a restricted area and a security problem may thus occur.

In order to prevent this situation, biometric technologies which automatically recognize or confirm the identity of an individual by using human biometric or behavioral features have been developed. For example, biometric systems have been used in banks, airports, high-security facilities, and so on. Accordingly, much research for easier applications and higher reliability of biometric systems has been made.

A biometric system is an individual identification and authentication system using physical features. The International Biometric Technology Association defines the biometric technology as being a ‘study that explores measurable physical features or individual features to verify a specific individual or recognize the identity of an individual using an automatic means’. The individual biometrics features cannot be stolen, changed, or lost.

Individual features used in biometric system include fingerprint, face, palm print, hand geometry, thermal image, voice, signature, vein shape, typing keystroke dynamics, retina, iris etc. Particularly, face recognition technology is most widely used by an operator to identify a person.

However, in conventional face recognition technology, an identity of a person is determined by comparing the features of the structure of the person's face. Thus, factors such as illumination, face expression, and face pose severely affect the face recognition rate, and even more, a person can be wrongly identified as another person.

### BRIEF SUMMARY

An aspect of the present invention provides a method of constructing classifiers based on face texture information.

An aspect of the present invention also provides a method of recognizing a face by checking similarity of face texture information extracted by the constructed classifiers.

An aspect of the present invention also provides an apparatus for constructing classifiers based on face texture information.

An aspect of the present invention also provides an apparatus for recognizing a face by checking similarity of face texture information extracted by the constructed classifier.

According to an aspect of the present invention, a method of constructing classifiers based on face texture information is provided, including: cropping the first face image and the second face image from two different images, which are to be compared; dividing the first face image and the second face image into sub-images with predetermined size and constructing the corresponding partial images of the first face image and the corresponding partial images of the second face image; extracting corresponding texture information of each of partial images of the first face image and corresponding texture information of each of partial images of the second face image; checking the texture similarity between each of partial images of the first face image and that of the corresponding partial images of the second face image; and constructing weak classifiers for recognizing an identity of the face according to the checked texture similarities.

According to an aspect of the present invention, a method of recognizing a face using statistical features of face texture information is provided, including: cropping a face image; cropping partial images, based on which weak classifiers will be constructed for effectively recognizing the face cropped from image; extracting texture information from each of the cropped partial images; checking the texture similarities between the extracted texture information of the partial images and that of the corresponding partial images of the reference face images, previously stored; and recognizing an identity of the face according to the checked similarities.

According to an aspect of the present invention, an apparatus of constructing classifiers based on face texture information is provided, including: a face image cropper cropping the first face image and the second face image from two different images; a partial image generator dividing the first face image and the second face image into partial images with predetermined size and constructing corresponding partial images of the first face image and corresponding partial images of the second face image; a texture information extractor extracting corresponding texture information of each of partial images of the first face image and corresponding texture information of each of partial images of the second face image; a texture similarity checking unit checking texture similarities between each of partial images of the first face image and that of the corresponding partial images of the second face image; and a weak classifier constructor constructing weak classifiers for recognizing an identity of the face according to the checked similarities.

According to an aspect of the present invention, an apparatus of recognizing a face using statistical features of texture information is provided, including: a face image cropper cropping a face image; a partial image cropper cropping partial images, based on which weak classifiers will be constructed to effectively recognize the face; a texture information extractor extracting texture information of each of the cropped partial images; a texture similarity checking unit checking texture similarities between the extracted texture information and texture information of the reference face, previously stored; and a face recognizer recognizing an identity of the face according to the checked similarities.

According to an aspect of the present invention, computer-readable storage media encoded with processing instructions for causing a processor to execute the above-described methods are provided.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart illustrating a method of constructing classifiers based on face texture information according to an embodiment of the present invention;

FIG. 2 is a flowchart illustrating operation 14 shown in FIG. 1 according to an embodiment of the present invention;

FIG. 3 illustrates an example of a method of constructing weak classifiers shown in FIG. 1;

FIG. 4 illustrates an example of a method of constructing strong classifiers shown in FIG. 1;

FIG. 5 is a flowchart illustrating a method of recognizing a face using statistical features based on face texture information according to an embodiment of the present invention;

FIG. 6 is a flowchart illustrating operation 54 shown in FIG. 5 according to an embodiment of the present invention;

FIG. 7 is a block diagram of an apparatus for constructing classifiers based on face texture information according to an embodiment of the present invention;

FIG. 8 is a block diagram of a texture information extractor shown in FIG. 7 according to an embodiment of the present invention;

FIG. 9 is a block diagram of an apparatus for recognizing a face using statistical features of face texture information according to an embodiment of the present invention; and

FIG. 10 is a block diagram of a texture information extractor shown in FIG. 9 according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

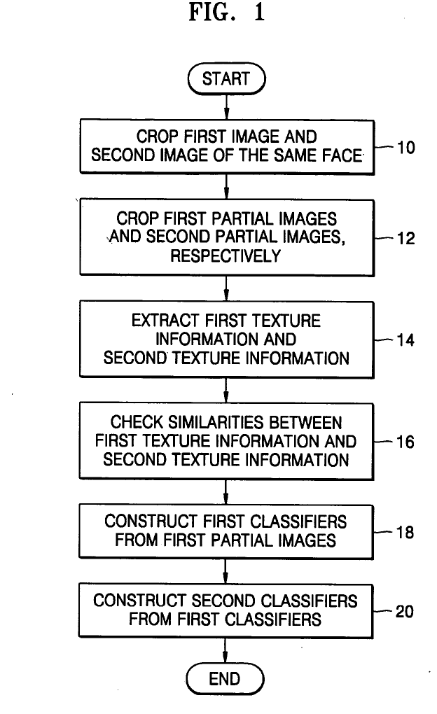

FIG. 1 is a flowchart illustrating a method of constructing classifiers based on face texture information according to an embodiment of the present invention. In operation 10, the first face image and the second face image are cropped from two different images, which are to be compared. The first and second face images may be cropped both from the frontal faces. If the face images are cropped from faces with pose or expression, the face images are normalized based on the location of the eyes of the face.

The first and second face images are filtered using a Gaussian low pass filter so that noise can be removed therefrom.

After operation 10, in operation 12, the first and second face images are respectively divided into partial images with predetermined size, and the partial images of the first face image and the partial images of the second face image are cropped. A window with a predetermined size is used to crop the first partial images, and a window with a predetermined size is used to crop the second partial images. For example, if the size of the first and second face images is of 130×150 pixels, the first and second partial images with a predetermined window size of 20×20 pixels are respectively cropped.

Predetermined portions of the first partial images respectively overlap with one another. For example, a partial image overlaps with another partial image by a predetermined number of pixels. Thus, adjacent partial images share the same image in an overlapped region. Also, predetermined portions of the second partial images respectively overlap with one another.

After operation 12, in operation 14, first texture information corresponding to each of the first partial images and second texture information corresponding to each of the second partial images are extracted.

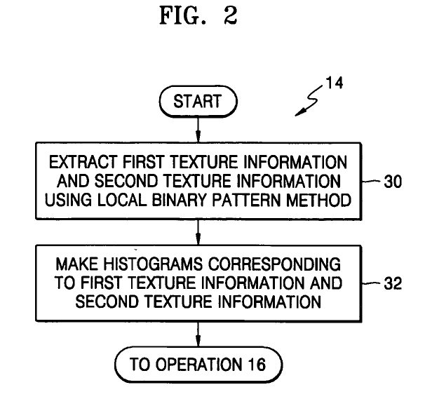

FIG. 2 is a flowchart illustrating operation 14 shown in FIG. 1 according to an embodiment of the present invention. First, in operation 30, the first texture information and second texture information are extracted from the first partial images and the second partial images using a local binary pattern (LBP) method or morphological wavelets.

In particular, the first texture information and the second texture information are extracted using one of a Haar morphology wavelet method, a median morphology wavelet method, an Erodent morphology wavelet method, and an expanded morphology wavelet method.

The morphology wavelet method is a method by which desired information is extracted from a predetermined digital signal using a morphology operation. The morphology wavelet method is well-known in the art and thus a detailed description thereof will be omitted. Detecting of the texture information using the Haar morphology wavelet method will now be described briefly. The Haar morphology wavelet method uses Equation 1.
Sₙ=min[x₂ₙ, x₂ₙ₊₁]
dₙ=x₂ₙ−x₂ₙ₊₁ (1),
where x₂ₙ and x₂ₙ₊₁ are pixel values, respectively, Sₙ is a minimum pixel value between x₂ₙ and x₂ₙ₊₁, and dₙ is a difference between the pixels values x₂ₙ and x₂ₙ₊₁. The above operation is repeatedly performed in horizontal and vertical directions of the partial images using Equation 1, to detect the texture information.

Returning to FIG. 1, after operation 30, in operation 32, histograms of the first texture information and the second texture information are respectively obtained. Histograms of the number of pixels according to brightness of pixels of the first texture information and the second texture information are obtained. The horizontal axis represents divided brightness of predetermined sizes (for example, brightness divided into 256 steps), and the vertical axis represents the number of pixels for each brightness included in one texture information.

After operation 14, in operation 16, texture similarities between each of the first partial images and that of the corresponding partial images of the second face image. The first texture information and the second texture information, the histograms of which are obtained in operation 32, are compared with each other and similarities there between are checked. That is, the number of the pixels according to brightness of specific texture information of the first texture information and the number of the pixels according to brightness of texture information corresponding to the specific texture information of the second texture information are compared with each other and similarities there between are checked.

In this way, all texture similarities between the partial images of the first face image and the corresponding partial images of the second face are checked. In particular, the similarities are checked using one of a Chi square distance, a Kullback-Leibler distance, and a Jensen-Shannon distance. Similarities with respect to a variation in texture of images are determined using the histograms. Similarities between the histograms are compared using one of the Chi square distance, the Kullback-Leibler distance, and the Jensen-Shannon distance.

Similarities using the Chi square distance are determined using Equation 2.

$$D ( S , M ) = {\sum }_{i} \frac{{( {S}_{i} - {M}_{i} )}^{2}}{( {S}_{i} + {M}_{i} )} , \qquad ( 2 )$$

where Sᵢ is the number of pixels for i-th brightness of specific texture information of the first texture information and Mᵢ is the number of pixels for i-th brightness of texture information corresponding to the specific texture information of the second texture information.

Similarities using the Kullback-Leibler distance are determined using Equation 3 or 4.

$$\begin{matrix}KL ( S , M ) = {\sum }_{i} {S}_{i} log \frac{{S}_{i}}{{M}_{i}} & ( 3 ) \\ KL ( S , M ) = {\sum }_{i} ( {S}_{i} log \frac{{S}_{i}}{{M}_{i}} + {M}_{i} log \frac{{M}_{i}}{{S}_{i}} ) & ( 4 )\end{matrix}$$

where Sᵢ is the number of pixels of i-th brightness of specific texture information of the first texture information and Mᵢ is the number of pixels of i-th brightness of texture information corresponding to the specific texture of the second texture information.

Similarities using the Jensen-Shannon distance are determined using Equation 5.

$$JS ( S , M ) = {\sum }_{i} ( {S}_{i} log \frac{{S}_{i}}{{S}_{i} + {M}_{i}} + {M}_{i} log \frac{{M}_{i}}{{S}_{i} + {M}_{i}} ) , \qquad ( 5 )$$

where Sᵢ is the number of pixels of i-th brightness of specific texture information of the first texture information and Mᵢ is the number of pixels of i-th brightness of texture information corresponding to the specific texture of the second texture information. When the Chi square distance, the Kullback-Leibler distance or the Jensen-Shannon distance obtained from the histograms of the texture information is smaller than a predetermined value, the first image and the second image are similar to each other.

The Chi square distance, the Kullback-Leibler distance, and the Jensen-Shannon distance are obtained from all partial image pairs between each partial image of first face image and the corresponding partial image of the second face image. The texture similarity values of each partial image pair are used to construct weak classifiers which will be described later.

After operation 16, in operation 18, weak classifiers, built based on texture similarities, are used to recognize the identity of the face, from which the partial images are cropped. Texture similarity value obtained using one of the Chi square distance, the Kullback-Leibler distance, and the Jensen-Shannon distance is used to construct weak classifier by comparing it with a predetermined threshold value. That is, the weak classifiers are obtained by extracting texture information from partial images that can be effectively used to recognize the identity of the face.

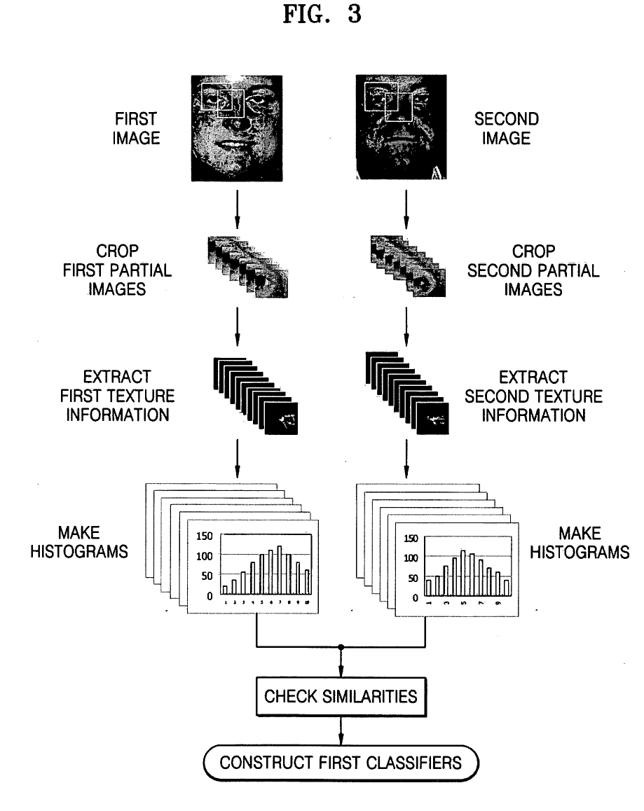

FIG. 3 illustrates an example of a method of constructing weak classifiers shown in FIG. 1. First, the first face image and the second face image are cropped. The partial images of the first face image and the partial images of the second face image are cropped. The first texture information of each of the first partial images and the second texture information of each of the second partial images are extracted. Histograms of each of partial images of the first face image are obtained and histograms of each of partial images of the second face image are obtained. Texture similarities between partial images of the first face image and corresponding partial images of the second face image are checked, and the weak classifiers that can be used to effectively identify the face are constructed from the checked similarities.

The above-described operations 12 through 18 of FIG. 1 are repeatedly performed by changing the size of windows for each of the partial images cropped from the first face image and the second face image so that other weak classifiers are constructed. In this way, the weak classifiers based on different window sizes can be constructed.

After operation 18, in operation 20, strong classifiers that can be used to effectively recognize the identity of the face are constructed from the weak classifiers using a Bayesian network technology. A Bayesian network is a tool for modeling the cause and effect relation between probability variables and is widely used to deduce a software user's help. The weak classifiers are divided into many group classifiers, and each group classifiers have high relativity, a confidence value for each of the weak classifiers is learned using the Bayesian network method, and the learned confidence value is multiplied by the weak classifiers so that the strong classifiers are detected.

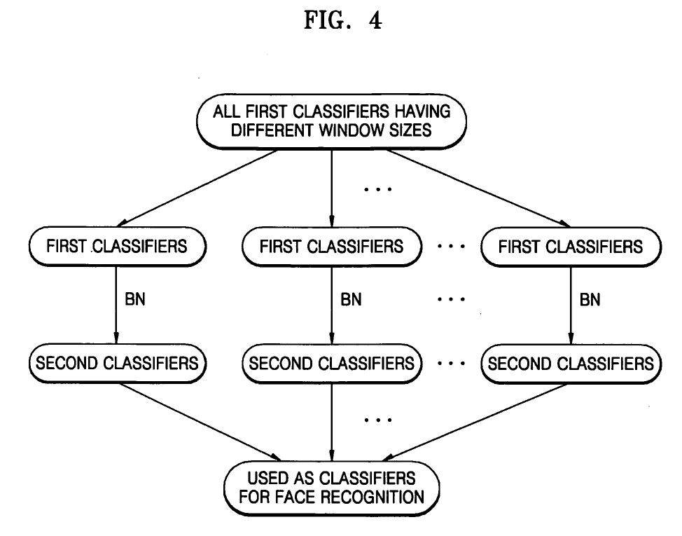

FIG. 4 illustrates an example of a method of constructing strong classifiers shown in FIG. 1. As shown in FIG. 4, the weak classifiers with different window sizes constructed by repeatedly performing operations 12 through 16 of FIG. 1 are divided into several group classifiers with the same window size and each of the strong classifiers is constructed from the weak classifiers using a Bayesian network technology. The strong classifiers are used as a method of recognizing a face using statistical features of texture information, which will be described later.

The method of recognizing a face using statistical features of texture information according to an embodiment of the present invention will now be described with reference to the accompanying drawings.

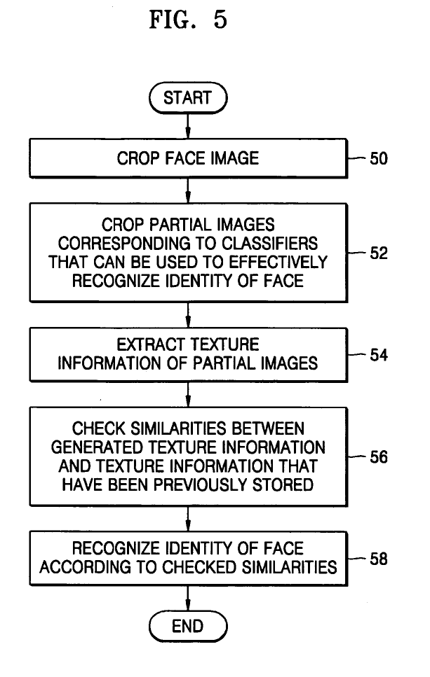

FIG. 5 is a flowchart illustrating a method of recognizing a face using statistical features of texture information according to an embodiment of the present invention. First, in operation 50, a face image is cropped. If the face image is cropped from those faces with pose or expression, the face image is normalized based on the location of the eyes of the face. The cropped image is filtered using a Gaussian low pass filter so that noise therefore can be removed.

After operation 50, in operation 52, partial images, based on which classifiers will be constructed for effectively recognizing the identity of the face, are cropped from the cropped image. Information of the classifiers that can be used to effectively recognize the identity of the face is provided by using the method of constructing classifiers shown in FIG. 1. In particular, strong classifiers constructed using the Bayesian network technology are used as classifiers to effectively recognize the identity of the face. Predetermined portions of the cropped partial images respectively overlap with one another. For example, a partial image overlaps with another partial image by a predetermined pixel. Thus, the adjacent partial images share the same image in an overlapped region.

After operation 52, in operation 54, texture information of each of the cropped partial images is generated.

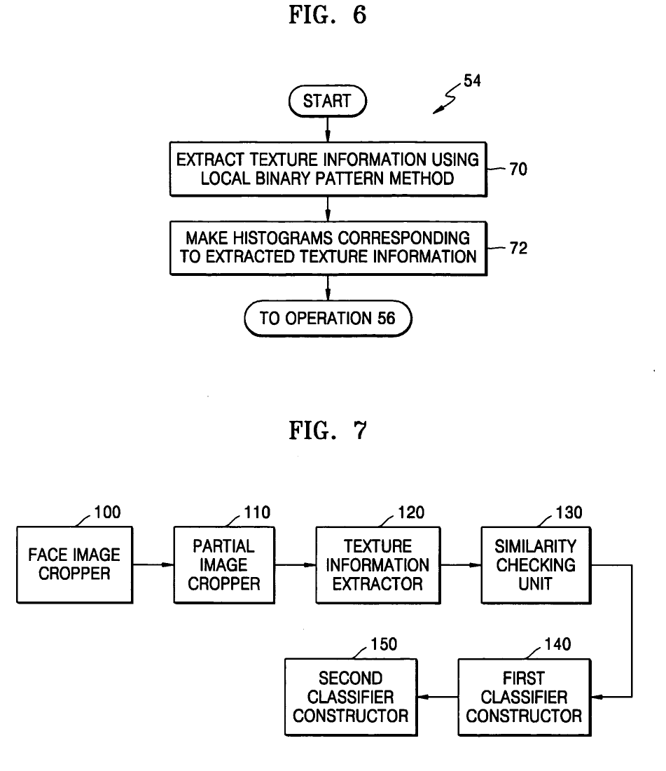

FIG. 6 is a flowchart illustrating operation 54 shown in FIG. 5 according to an embodiment of the present invention. First, in operation 70, the texture information is extracted from each of divided partial images using local binary pattern (LBP) method or morphological wavelet approach. In particular, first texture information and second texture information are extracted using any one of LBP method, Haar morphology wavelet method, a median morphology wavelet method, an Erodent morphology wavelet method, and an expanded morphology wavelet method.

After operation 70, in operation 72, histograms of each of the extracted texture information are respectively obtained. The number of pixels according to brightness of pixels of the extracted texture information is obtained. The horizontal axis represents divided brightness of predetermined sizes (for example, brightness divided into 256 steps), and the vertical axis represents the number of pixels for each brightness included in one texture information.

Returning to FIG. 5, after operation 54, in operation 56, texture similarities between the extracted texture information and the texture information that have been previously stored are checked. Similarities between the histograms of the texture information generated in operation 70 and the histograms of the texture information that have been previously stored are checked.

In particular, the similarities are checked using one of a Chi square distance, a Kullback-Leibler distance, and a Jensen-Shannon distance. After operation 56, in operation 58, the identity of the face is recognized according to the checked similarities.

If the average of values obtained by checking the similarities between each of the texture information using one of the Chi square distance, the Kullback-Leibler distance, and the Jensen-Shannon distance is less than a predetermined threshold value, the face from which the face image is cropped is recognized as corresponding to a person's face that has been previously stored. However, if the average of the checked values is not less than the predetermined threshold value, the face from which the face image is cropped is recognized as not corresponding to a person's face that has been previously stored. The method of recognizing the identity of the face by comparing the average of the checked values with the predetermined threshold value is only an example and other modifications are possible.

The apparatus for constructing classifiers based on texture information of a face according to an embodiment of the present invention will now be described with reference to the accompanying drawings.

FIG. 7 is a block diagram of the apparatus for constructing classifiers based on face texture information according to an embodiment of the present invention. The apparatus includes a face image cropper 100, a partial image cropper 110, a texture information generator 120, a texture similarity checking unit 130, a first (weak) classifier constructor 140, and a second (strong) classifier constructor 150.

The face image cropper 100 crops a first face image and a second face image from two different images. The face image cropper 100 crops the first face image or the second face image from a frontal face. The face image cropper 100 filters the first face image or the second face image using a Gaussian low pass filter, thereby removing noise from the face.

The partial image cropper 110 divides the first face image or the second face image into partial images of predetermined sizes and crops first partial images corresponding to the first face image or second partial images corresponding to the second face image. The partial image cropper 110 uses a window with a predetermined size to crop the first partial images from the first face image. In addition, the partial image cropper 110 uses a window with a predetermined size to crop the second partial images from the second face image.

The partial image cropper 110 crops images so that predetermined portions of the first partial images respectively overlap with one another or predetermined portions of the second partial images respectively overlap with one another. The partial image cropper 110 crops the images so that an image overlaps with another image by a predetermined pixel. Thus, the adjacent partial images share the same image in an overlapped region.

The texture information generator 120 generates first texture information corresponding to each of the first partial images cropped by the partial image detector 110 or second texture information corresponding to each of the second partial images cropped by the partial image detector 110.

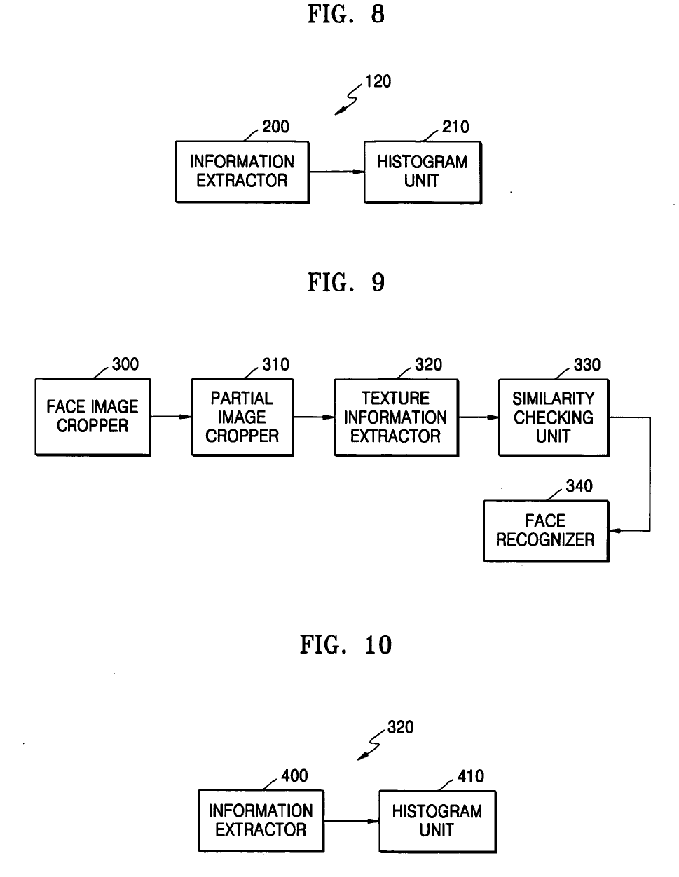

FIG. 8 is a block diagram of the texture information generator 120 shown in FIG. 7 according to an embodiment of the present invention. The texture information generator 120 includes an information extractor 200 and a histogram unit 210.

The information extractor 200 extracts first texture information from first partial images or second texture information from second partial images using local binary pattern (LBP) method or morphological wavelets.

The information extractor 200 uses any one of LBP method, Haar morphology wavelet method, a median morphology wavelet method, an Erodent morphology wavelet method, and an expanded morphology wavelet method.

The histogram unit 210 makes histograms corresponding to the first texture information or the second texture information extracted by the information detector 200. The histogram unit 210 makes histograms corresponding to the number of pixels for each of the first texture information and the second texture information according to brightness. The horizontal axis of the histograms of texture information represents divided brightness of predetermined sizes (for example, brightness divided into 256 steps), and vertical axis thereof represents the number of pixels for each brightness included in one texture information.

Returning to FIG. 7, the texture similarity checking unit 130 checks similarities between the texture information of partial images of the first face image and that of the corresponding partial images of the second image, the histograms of which are obtained by the histogram unit 210 of FIG. 8, by comparing the first texture information with the second texture information. That is, the similarity checking unit 130 checks the texture similarity between the first texture information and the second texture information by comparing the number of pixels according to brightness of specific texture information of the first texture information with the number of the pixels according to brightness of texture information corresponding to the specific texture information of the second texture information. The similarity checking unit 130 checks all similarities between the first texture information of all partial images and that of the corresponding second partial images in this way.

In particular, the similarity checking unit 130 checks the similarities using one of a Chi square distance, a Kullback-Leibler distance, and a Jensen-Shannon distance. The method of checking the similarities using one of the Chi square distance, the Kullback-Leibler distance, and the Jensen-Shannon distance has been described above.

The first classifier constructor 140 constructs weak classifiers that can be used to recognize the identity of the face based on the first partial images according to the similarities checked by the similarity checking unit 130. When the result obtained by checking the similarities between each of the texture information using one of the Chi square distance, the Kullback-Leibler distance, and the Jensen-Shannon distance is input into the weak classifier detector 140, the weak classifier constructor 140 constructs the texture information in which the checked value is less than a predetermined threshold value as the weak classifiers.

The strong classifier constructor 150 constructs strong classifiers that can be used to effectively recognize the identity of the face with the weak classifiers using the Bayesian network technology.

The apparatus for recognizing a face using statistical features of texture information according to an embodiment of the present invention will now be described with reference to the accompanying drawings.

FIG. 9 is a block diagram of an apparatus for recognizing a face using statistical characteristics of texture information according to an embodiment of the present invention. The apparatus includes a face image cropper 300, a partial image cropper 310, a texture information generator 320, a similarity checking unit 330, and a face recognizer 340.

The face image cropper 300 crops an image of a face and outputs the cropped result to the partial image cropper 310.

The face image cropper 300 crops the image from a frontal face. The face image cropper 300 filters the cropped image using a Gaussian low pass filter to remove noise from the face.

The partial image cropper 310 crops partial images, based on which classifiers will be constructed to effectively recognize the identity of the face of the cropped image and outputs the cropped result to the texture information generator 320. The partial image cropper 310 includes information on the classifiers that can be used to effectively recognize the identity of the face that has been previously cropped using the apparatus for constructing classifiers for face recognition shown in FIG. 7. In particular, the partial image cropper 310 uses strong classifiers constructed using a Bayesian network technology as classifiers that can be used to effectively recognize the identity of the face.

The partial image cropper 310 crops the images so that predetermined portions of the cropped partial images respectively overlap with one another. The texture information generator 320 generates texture information of each of the partial images cropped by the partial image detector 310 and outputs the generated result to the similarity checking unit 330.

FIG. 10 is a block diagram of the texture information generator 320 shown in FIG. 9 according to an embodiment of the present invention. The texture information generator 320 includes an information detector 400 and a histogram unit 410.

The information extractor 400 extracts texture information from partial images using local binary pattern (LBP) method or morphological wavelets. In particular, the information extractor 400 uses any one of LBP method, Haar morphology wavelet method, a median morphology wavelet method, an Erodent morphology wavelet method, and an expanded morphology wavelet method.

The histogram unit 410 makes histograms of the extracted texture information. The histogram unit 410 makes histograms corresponding to the number of pixels for each of the first texture information and the second texture information according to brightness. The horizontal axis of the histograms of texture information represents divided brightness of predetermined sizes (for example, brightness divided into 256 steps), and the vertical axis thereof represents the number of pixels for each brightness included in one texture information.

The similarity checking unit 330 checks similarities between the generated texture information and texture information of a face image that has been previously stored. The similarity checking unit 330 compares similarities between the histograms of the texture information generated by the histogram unit 410 with the histograms of the texture information of the face images that have been previously stored in a predetermined storage space to recognize the identity of the face.

The similarity checking unit 330 checks the similarities using one of a Chi square distance, a Kullback-Leibler distance, and a Jensen-Shannon distance.

The face recognizer 340 recognizes the identity of the face according to the similarities checked by the similarity checking unit 330.

If the average of values obtained by checking the similarities between each of the texture information using one of the Chi square distance, the Kullback-Leibler distance, and the Jensen-Shannon distance is less than a predetermined threshold value, the face recognizer 340 identifies the face from which the image is detected as corresponding to a person's face that has been previously stored. However, if the average of the checked values is not less than the predetermined threshold value, the face recognizer 340 recognizes the face from which the image is detected as not corresponding to a person's face that has been previously stored. The method of recognizing the identity of the face by comparing the average of the checked values with the predetermined threshold value using the face recognizer 340 is only an example and the identity of the face can be determined using different values.

Embodiments of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

In the method and the apparatus for recognizing a face using statistical characteristics of texture information according to the above-described embodiments of the present invention, the identity of the face is determined using face texture information such that face recognition errors due to illumination, expression, and face pose are prevented.

In the method and the apparatus for detecting classifiers having face texture information according to the above-described embodiments of the present invention, classifiers that can be used to effectively recognize the face can be effectively and rapidly detected.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of constructing classifiers based on face texture information, comprising:
(a) cropping a first face image and a second face image from two different images;
(b) dividing the first face image and the second face image into partial images of predetermined sizes and cropping first partial images corresponding to the first face image and second partial images corresponding to the second face image;
(c) extracting first texture information corresponding to texture information of each of the first partial images and second texture information corresponding to texture information of each of the second partial images;
(d) checking similarities between each of the first texture information and the second texture information corresponding to the first texture information; and
(e) constructing weak classifiers for recognizing an identity of the face based on the partial images according to the checked similarities.

2. The method of claim 1, wherein operation (a) comprises cropping the first face image and the second face image from a frontal face.

3. The method of claim 1, wherein operation (a) comprises filtering the first face image and the second face image using a Gaussian low pass filter.

4. The method of claim 1, wherein operation (b) comprises respectively overlapping predetermined portions of the first partial images and respectively overlapping predetermined portions of the second partial images.

5. The method of claim 1, wherein operation (c) comprises:
(c1) extracting the first texture information and the second texture information from each of the first partial images and the second partial images using local binary pattern (LBP) method or morphological wavelets; and
(c2) obtaining histograms of each of the first texture information and the second texture information.

6. The method of claim 5, wherein operation (c1) comprises using one of a Haar morphology wavelet method, a median morphology wavelet method, an Erodent morphology wavelet method, and an expanded morphology wavelet method.

7. The method of claim 1, wherein operation (d) comprises checking the similarities using one of a Chi square distance, a Kullback-Leibler distance, and a Jensen-Shannon distance.

8. The method of claim 1, comprising repeatedly performing operation (b) through (e) by changing sizes of the cropped images, after operation (a).

9. The method of claim 1, further comprising (f) constructing strong classifiers for recognizing the identity of the face based on the weak classifiers using a Bayesian network technology.

10. A method of recognizing a face using statistical features of texture information, the method comprising:
(a) cropping a face image;
(b) cropping partial images, based on which classifiers are constructed for effectively recognizing the face of the cropped image;
(c) extracting texture information of each of the cropped partial images;
(d) checking similarities between the extracted texture information and texture information of the face that has been previously stored; and
(e) recognizing an identity of the face according to the checked similarities.

11. The method of claim 10, wherein operation (a) comprises cropping the image from a frontal face.

12. The method of claim 10, wherein operation (a) comprises filtering the image using a Gaussian low pass filter.

13. The method of claim 10, wherein operation (b) comprises cropping the partial images using a Bayesian network technology.

14. The method of claim 10, wherein operation (b) comprises respectively overlapping predetermined portions of the partial images.

15. The method of claim 10, wherein operation (c) comprises:
(c1) extracting the texture information from each of the partial images using local binary pattern (LBP) method or morphological wavelets; and
(c2) obtaining histograms of the extracted texture information.

16. The method of claim 15, wherein operation (c1) comprises using one of a Haar morphology wavelet method, a median morphology wavelet method, an Erodent morphology wavelet method, and an expanded morphology wavelet method.

17. The method of claim 10, wherein operation (d) comprises checking the similarities using one of a Chi square distance, a Kullback-Leibler distance, and a Jensen-Shannon distance.

18. An apparatus for constructing classifiers based on face texture information, the apparatus comprising:
a face image cropper cropping a first face image and a second face image from two different images;
a partial image cropper dividing the first face image and the second face image into partial images of predetermined sizes and cropping first partial images corresponding to partial images of the first image and second partial images corresponding to partial images of the second image;
a texture information generator generating first texture information corresponding to each of the first partial images and second texture information corresponding to each of the second partial images;
a similarity checking unit checking similarities between each of the first texture information and the second texture information corresponding to the first texture information; and
a first classifier constructor constructing weak classifiers for recognizing an identity of the face from the first partial images according to the checked similarities.

19. The apparatus of claim 18, wherein the face image cropper crops the first image or the second image from a frontal face.

20. The apparatus of claim 18, wherein the face image detector filters the first image or the second image using a Gaussian low pass filter.

21. The apparatus of claim 18, wherein the partial image cropper crops images to respectively overlap predetermined portions of the first partial images or detects images to respectively overlap predetermined portions of the second partial images.

22. The apparatus of claim 18, wherein the texture information generator comprises:
an information extractor extracting the first texture information from the first partial images or the second texture information from the second partial images using local binary pattern (LBP) method or morphological wavelets; and
a histogram unit obtaining histograms of the first texture information or the second texture information.

23. The apparatus of claim 22, wherein the information extractor uses one of a Haar morphology wavelet method, a median morphology wavelet method, an Erodent morphology wavelet method, and an expanded morphology wavelet method.

24. The apparatus of claim 18, wherein the similarity checking unit checks the similarities using one of a Chi square distance, a Kullback-Leibler distance, and a Jensen-Shannon distance.

25. The apparatus of claim 18, further comprising a strong classifier constructor constructing strong classifiers from the weak classifiers using a Bayesian network technology to effectively recognize the identity of the face.

26. An apparatus for recognizing a face using statistical features of texture information, the apparatus comprising:
a face image cropper cropping a face image;
a partial image cropper cropping partial images, based on which classifiers are constructed to effectively recognize the face from the detected image;
a texture information generator generating texture information of each of the cropped partial images;
a similarity checking unit checking similarities between the generated texture information and texture information of the face that has been previously stored; and
a face recognizer recognizing an identity of the face according to the checked similarities.

27. The apparatus of claim 26, wherein the face image cropper crops the image from a frontal face.

28. The apparatus of claim 26, wherein the face image cropper filters the image using a Gaussian low pass filter.

29. The apparatus of claim 26, wherein the partial image cropper crops the partial images using a Bayesian network technology.

30. The apparatus of claim 26, wherein the partial image cropper crops images to respectively overlap predetermined portions of the partial images.

31. The apparatus of claim 26, wherein the texture information generator comprises:
an information extractor extracting the texture information from each of the partial images using local binary pattern (LBP) method or morphological wavelets; and
a histogram unit obtaining histograms of the extracted texture information.

32. The apparatus of claim 31, wherein the information extractor uses one of a Haar morphology wavelet method, a median morphology wavelet method, an Erodent morphology wavelet method, and an expanded morphology wavelet method.

33. The apparatus of claim 26, wherein the similarity checking unit checks the similarities using one of a Chi square distance, a Kullback-Leibler distance, and a Jensen-Shannon distance.

34. A computer-readable storage medium encoded with processing instructions for causing a processor to execute a method of constructing classifiers based on face texture information, the method comprising:
(a) cropping a first face image and a second face image from two different images;
(b) dividing the first face image and the second face image into partial images of predetermined sizes and cropping first partial images corresponding to the first face image and second partial images corresponding to the second face image;
(c) extracting first texture information corresponding to texture information of each of the first partial images and second texture information corresponding to texture information of each of the second partial images;
(d) checking similarities between each of the first texture information and the second texture information corresponding to the first texture information; and
(e) constructing weak classifiers for recognizing an identity of the face based on the partial images according to the checked similarities.

35. A computer-readable storage medium encoded with processing instructions for causing a processor to execute a method of recognizing a face using statistical features of texture information, the method comprising:
(a) cropping a face image;
(b) cropping partial images, based on which classifiers are constructed for effectively recognizing the face of the cropped image;
(c) extracting texture information of each of the cropped partial images;
(d) checking similarities between the extracted texture information and texture information of the face that has been previously stored; and
(e) recognizing an identity of the face according to the checked similarities.
